(19) United States
(12) Patent Application Publication
(10) Pub. No.: US 2017/0058814 A1
(43) Pub. Date: Mar. 2, 2017

(54) FUEL MANAGEMENT SYSTEM FOR HYBRID VEHICLE AND CONTROL METHOD THEREOF

(71) Applicant: Hyundai Motor Company, Seoul (KR)

(72) Inventors: Cheol Hun Cho, Suwon (KR); Jeong Seok Lee, Seoul (KR); Ju Tae Song, Hwaseong (KR)

(21) Appl. No.: 14/954,366

(22) Filed: Nov. 30, 2015

(30) Foreign Application Priority Data
Aug. 26, 2015 (KR) 10-2015-0120185

(51) Int. Cl. F02D 41/30

(52) U.S. Cl. CPC F02D 41/3005

(57) ABSTRACT

A fuel management system for a hybrid vehicle driven by an electric motor and an internal combustion engine is provided. The system includes a check unit that detects a time in which the internal combustion engine was last operated and stores the detected time as an engine driving point in time. A controller receives the stored engine driving point in time and determines that a fuel remaining in a fuel tank is aged when a time period elapsing from the engine driving point in time reaches a set fuel leaving time period, to operate the internal combustion engine while the hybrid vehicle is driven.

### CROSS REFERENCE TO RELATED APPLICATION

The present application claims priority to Korean Patent Application No. 10-2015-0120185, filed Aug. 26, 2015, the entire contents of which is incorporated herein for all purposes by this reference.

### BACKGROUND

1. Technical Field

The present invention relates to a fuel management system and control method thereof for a hybrid vehicle capable of preventing corrosion of a fuel tank due to unused remaining fuel in consuming a fuel that remains unused for a substantial period of time in the hybrid vehicle.

2. Description of the Related Art

Generally, a hybrid vehicle, which is a vehicle driven by effectively combining two different types of driving sources, uses an engine and a motor generator. The hybrid vehicle uses the engine having good high speed torque characteristics and the motor generator having good low speed torque characteristics, to drive the vehicle using power of the motor generator as main driving force while being driven at a low speed and to drive the vehicle using power of the engine as main driving force while being driven at a high speed.

In addition, the hybrid vehicle efficiently combines the power of the engine and the power of the motor generator to secure sufficient driving force in various driving situations and allow fuel efficient driving to be performed. When the hybrid vehicle is driven using the motor generator without driving the engine, fuel such as gasoline is not consumed like an electric vehicle (EV), and when the hybrid vehicle is driven using the motor generator, the fuel is not consumed at all, and the fuel for driving the engine remains in a fuel tank.

When the fuel remaining in the fuel tank is unused for a substantial period of time, the fuel ages, and a short chain fatty acid is generated in the aged fuel, which may cause the fuel tank to corrode. When driving the engine using the aged fuel as described above, an engine driving component may be corroded or an engine output may be decreased. Therefore, in the hybrid vehicle, a method for solving a problem due to the fuel remaining for a substantial period of time has been required.

The contents described as the related art have been provided merely for assisting in the understanding for the background of the present invention and should not be considered as corresponding to the related art known to those skilled in the art.

### SUMMARY

An object of the present invention is to provide a fuel management system for a hybrid vehicle capable of consuming unused fuel by forcibly driving an engine while driving the hybrid vehicle, when an engine is not driven.

According to an exemplary embodiment of the present invention, a fuel management system for a hybrid vehicle driven by an electric motor and an internal combustion engine, may include: a check unit configured to detect a time in which the internal combustion engine is fmally operated and store the detected time as an engine driving point in time; and a controller configured to receive the stored engine driving point in time and determine that fuel in a fuel tank is aged when a period of time elapsing from the engine driving point in time reaches a set fuel leaving time period, thereby allowing the internal combustion engine to be forcibly operated while driving the hybrid vehicle.

The detected engine driving point in time may be a date and a time in which the internal combustion engine was fmally (was most recently or was last) operated. The check unit may be configured to detect whether an operation maintaining time after an operation of the internal combustion engine reaches a pre-stored driving confirmation time, and store a point in time in which the internal combustion engine is currently operated as the engine driving point in time when the operation maintaining time is the driving confirmation time or more.

The controller may be configured to operate the internal combustion engine for a pre-stored fuel consuming time or more when the time period elapsing from the engine driving point in time reaches the fuel leaving time period. The controller may further be configured to operate the electric motor or the internal combustion engine based on a driving state of the hybrid vehicle when the time period elapsing from the engine driving point in time does not reach the fuel leaving time period (e.g., fuel discharge time period).

According to another exemplary embodiment of the present invention, a fuel management system for a hybrid vehicle driven by an electric motor and an internal combustion engine, may include: a check unit configured to detect a time in which a fuel was finally (e.g., last or most recently) injected and store the detected time as a fuel injecting point in time; and a controller configured to receive the stored fuel injecting point in time and determine that fuel in a fuel tank is aged when a period elapsing from the fuel injecting point in time reaches a set fuel leaving time period, thereby allowing the internal combustion engine to be forcibly operated while driving the hybrid vehicle.

The detected fuel injecting point in time may be a date and a time in which the fuel was last injected. The check unit may be configured to store a point in time in which the fuel is currently injected as the fuel injecting point in time when a fuel amount change time in which a fuel amount is changed due to injection of the fuel into the fuel tank after the injection of the fuel is a pre-stored injecting confirmation time or more.

The controller may further be configured to operate the internal combustion engine for a pre-stored fuel consuming time or more when the period elapsing from the fuel injecting point in time reaches the fuel leaving time period. The controller may be configured to operate the electric motor or the internal combustion engine to be operated based on a driving state of the hybrid vehicle when the period elapsing from the fuel injecting point in time does not reach the fuel leaving time period.

### BRIEF DESCRIPTION OF THE DRAWINGS

A brief description of each drawing is provided to more sufficiently understand drawings used in the detailed description of the present invention.

FIG. 1 is a view illustrating a configuration of a fuel management system for a hybrid vehicle according to an exemplary embodiment of the present invention;

FIG. 2 is a flow chart illustrating processes of controlling the fuel management system for a hybrid vehicle according to an exemplary embodiment of the present invention; and

FIG. 3 is a flow chart illustrating processes of controlling the fuel management system for a hybrid vehicle according to an another exemplary embodiment of the present invention.

### DETAILED DESCRIPTION

Hereinafter, a fuel management system for a hybrid vehicle according to an exemplary embodiment of the present invention will be described with reference to the accompanying drawings.

It is understood that the term “vehicle” or “vehicular or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

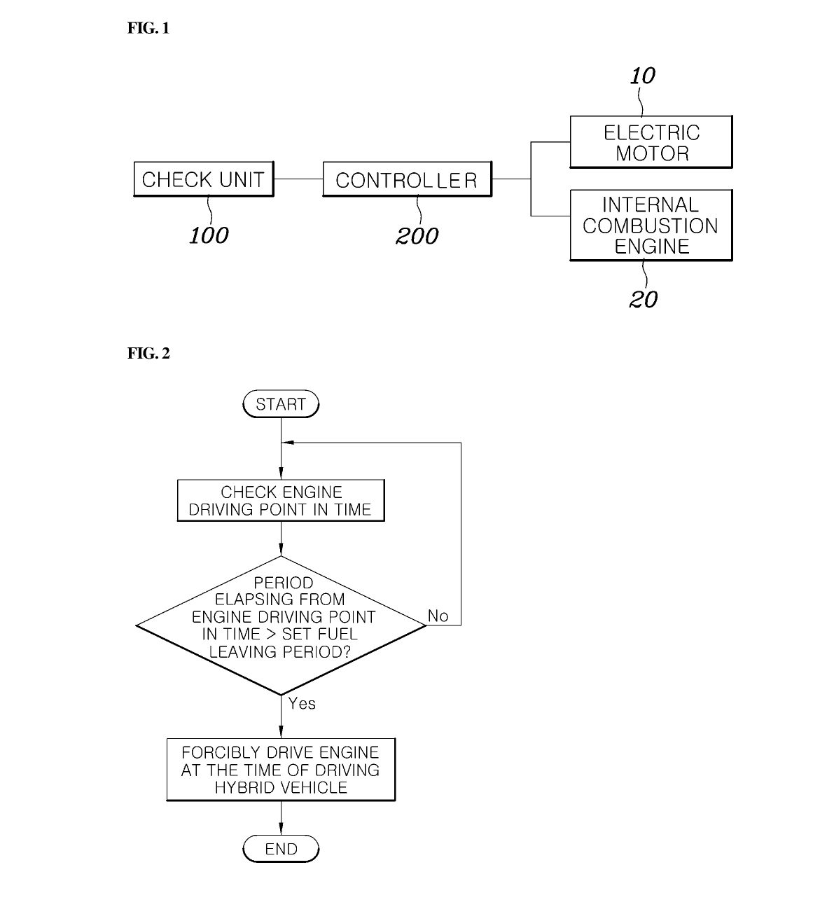

FIG. 1 is a view illustrating a configuration of a fuel management system for a hybrid vehicle according to an exemplary embodiment of the present invention, and FIG. 2 is a flow chart illustrating processes of controlling the fuel management system for a hybrid vehicle according to an exemplary embodiment of the present invention.

As illustrated in FIGS. 1 and 2, a fuel management system for a hybrid vehicle according to one of various exemplary embodiments of the present invention, which is a fuel management system for a hybrid vehicle driven by an electric motor 10 and an internal combustion engine 20, may include a check unit 100 (e.g., a sensor, a timer, or the like) configured to detect a time in which the internal combustion engine 20 was most recently (e.g., last, finally, etc.) operated and store the detect time as an engine driving point in time; and a controller 200 configured to receive the stored engine driving point in time and determine that a fuel in a fuel tank is aged when a period elapsing from the engine driving point in time reaches a set fuel leaving time period (e.g., a set fuel discharge time period), thereby allowing the internal combustion engine 20 to be forcibly operated while driving the hybrid vehicle.

Generally, the hybrid vehicle may be driven by the electric motor 10 and the internal combustion engine 20. In particular, the electric motor 10 may be operated by receiving power from a battery and the internal combustion engine 20 may be operated by receiving the fuel stored in the fuel tank. The hybrid vehicle may be driven by the electric motor 10, and a fuel consumption ratio may be significantly decreased while the hybrid vehicle is driven by the electric motor 10. Therefore, a situation in which the hybrid vehicle is driven using the electric motor 10 without using the internal combustion engine 20 may occur. In particular, when fuel remains in the fuel tank for a substantial period of time, the fuel may age thus causing the fuel tank to corrode.

In the present invention, which is to solve the above-mentioned problem, the check unit 100 may be configured to detect the time in which the internal combustion engine 20 was last operated and store the detected time as the engine driving point in time, and the controller 200 may be configured to determine that the fuel in the fuel tank is aged when the period elapsing from the engine driving point in time reaches the set fuel leaving time period, thereby allowing the internal combustion engine 20 to be forcibly operated while driving the hybrid vehicle to allow the fuel in the fuel tank to be consumed. The fuel leaving time period, which is a point in time in which a short chain fatty acid may be generated due to the aging of the fuel, may be derived through an experimental value, and may be set to be about nine months or more from the engine driving point in time as an example.

Meanwhile, the check unit 100 may be configured to detect the time in which the internal combustion engine 20 was last operated and store the detected time as the engine driving point in time. In other words, the check unit 100 may be configured to store a point in time in which the internal combustion engine 20 was last operated as the engine driving point in time, to thus determine how long (e.g., the amount of time that) the internal combustion engine 20 has not been operated. In particular, the detected engine driving point in time may be a date and a time in which the internal combustion engine 20 was last operated. The engine driving point in time may be stored as a date and a time at a point in time in which an operation of the internal combustion engine 20 is stopped, and a date and a time in which the internal combustion engine 20 was operated may be measured to more accurately determine a time period in which the fuel remains unused with the passage of time.

As described above, based on the detected engine driving point in time, the controller 200 may be configured to determine that the fuel in the fuel tank is aged when the period elapsing from the engine driving point in time reaches the set fuel leaving time period, thereby allowing the internal combustion engine 20 to be operated even when the electric motor 10 is to be operated based on fuel efficient driving (e.g., a driving mode) to allow the fuel in the fuel tank to be consumed.

However, when the hybrid vehicle repeatedly performs the fuel efficient driving, an operation of the internal combustion engine 20 is performed for a minimal period of time due to characteristics of the hybrid vehicle, and thus a minimal amount of fuel in the fuel tank may be used. In particular, the fuel remaining in the fuel tank may not be sufficiently used, and the fuel may not be consumed. Therefore, the remaining fuel may age. Therefore, the check unit 100 may be configured to detect whether an operation maintaining time after an operation of the internal combustion engine 20 reaches a pre-stored driving confirmation time, and store a point in time in which the internal combustion engine 20 is currently operated as the engine driving point in time when the operation maintaining time is the driving confirmation time or more.

In other words, the check unit 100 may be configured to detect the operation maintaining time in which the internal combustion engine 20 is maintained while operated, and determine that the internal combustion engine 20 is operated, and store a point in time in which the internal combustion engine 20 is operated and then stopped as the engine driving point in time, when the operation maintaining time of the internal combustion engine 20 is the driving confirmation time or more. Particularly, the driving confirmation time may be determined through an experimental value based on an amount of fuel consumed in the fuel tank during the operation of the internal combustion engine 20. For example, the driving confirmation time may be set to about 30 to 60 seconds.

As described above, the check unit 100 may be configured to store the point in time in which the internal combustion engine 20 is operated and then stopped as the engine driving point when the operation maintaining time in which the internal combustion engine 20 is maintained while operated is the driving confirmation time or more, thereby making it possible to allow the internal combustion engine 20 to be operated in an appropriate time based on the fuel leaving time period in the fuel tank.

Meanwhile, the controller 200 may be configured to operate the internal combustion engine 20 for a pre-stored fuel consuming time or more when the period elapsing from the engine driving point in time reaches the fuel leaving time period. In other words, when the engine driving point in time is the fuel leaving time period or more, and the fuel in the fuel tank is determined to be aged, the controller 200 may be configured to forcibly operate the internal combustion engine 20 while the hybrid vehicle is being driven, and adjust an operation time of the internal combustion engine 20 to be the pre-stored fuel consuming time or more, thereby allowing the fuel in the fuel tank to be sufficiently consumed. Particularly, the operation time may be, for example, a time of 20 minutes or more, and thus the internal combustion engine 20 may be sufficiently operated to allow the fuel in the fuel tank to be sufficiently consumed.

As described above, the controller may be configured to forcibly operate the internal combustion engine 20 for the fuel consuming time or more, thereby making it possible to allow the fuel in the fuel tank to be sufficiently consumed. Additionally, the controller 200 may be configured to operate the electric motor 10 or the internal combustion engine 20 based on a driving state of the hybrid vehicle when the period elapsing from the engine driving point in time does not reach (e.g., is less than) the fuel leaving time period.

In other words, when the period elapsing from the engine driving point in time does not reach the fuel leaving time period, the controller 200 may be configured to determine that the fuel in the fuel tank is not aged and may be configured to operate the electric motor 10 or the internal combustion engine 20 based on the driving state of the hybrid vehicle, thereby making it possible to drive the hybrid vehicle. As an example, when the period elapsing from the engine driving point in time does not reach the fuel leaving time period, the controller 200 may be configured to operate only the electric motor 10 during low speed torque driving and operate only the internal combustion engine 20 or both of the electric motor 10 and the internal combustion engine 20 during high speed torque driving, thereby making it possible to drive the hybrid vehicle.

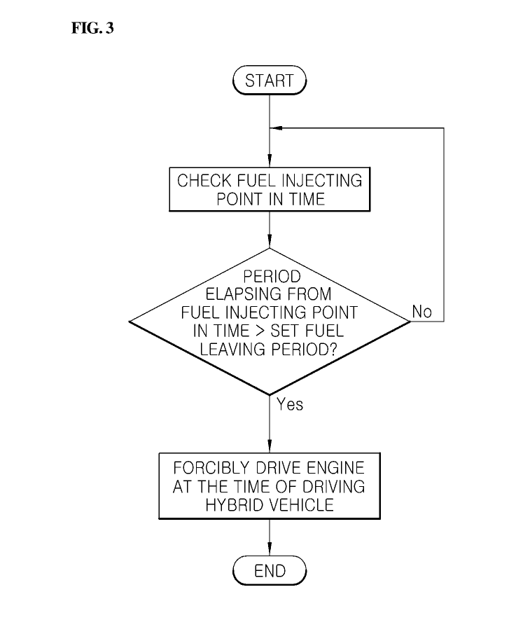

Meanwhile, as illustrated in FIGS. 1 and 3, a fuel management system for a hybrid vehicle according to another of various exemplary embodiments of the present invention, which is a fuel management system for a hybrid vehicle driven by an electric motor 10 and an internal combustion engine 20, may include a check unit 100 configured to detect a time in which a fuel was last injected and store the detected time as a fuel injecting point in time; and a controller 200 configured to receive the stored fuel injecting point in time and determine that a fuel in a fuel tank is aged when a time period elapsing from the fuel injecting point in time reaches a set fuel leaving time period, thereby allowing the internal combustion engine 20 to be forcibly operated while the hybrid vehicle is driven.

Particularly, the check unit 100 may be configured to detect the fuel injecting point in time based on whether an oil aperture or valve is open or closed using an oil valve sensor installed at the oil valve or a change amount of a residual fuel in the fuel tank. When the fuel injecting point in time is detected as described above, the controller 200 may be configured to determine that the fuel remaining in the fuel tank has been unused for a substantial period of time without being again supplied when the period elapsing from the fuel injecting point in time reaches the fuel leaving time period, thereby allowing the internal combustion engine 20 to be forcibly operated while the hybrid vehicle is driven to allow the remaining fuel to be consumed.

Moreover, the detected fuel injecting point in time may be a date and a time in which the fuel was last injected. In other words, the check unit 100 may be configured to store a point in time in which the fuel was last injected as the fuel injecting point in time, thereby making it possible to determine how long the residual fuel in the fuel tank has been unused. As described above, the date and the time in which the fuel was injected may be detected, thereby making it possible to more accurately determine a time period in which the fuel has been unused with the passage of time.

Furthermore, the check unit may be configured to store a point in time in which the fuel is currently injected as the fuel injecting point in time when a fuel amount change time in which a fuel amount is changed due to injection of the fuel into the fuel tank after injection of the fuel is a pre-stored injecting confirmation time or more.

In other words, the check unit 100 may be configured to detect the fuel amount change time in which the fuel amount is changed due to the injection of the fuel, determine that the fuel is actually injected when the fuel amount change time is the injecting confirmation time or more, and store a point in time in which the fuel is actually injected as the fuel injecting point in time. Particularly, the injecting confirmation time or more may be determined through an experimental value based on a change amount of the fuel at the time of injecting the fuel into the fuel tank. For example, the injecting confirmation time may be set to about 15 seconds.

As described above, the check unit 100 may be configured to store the point in time in which the fuel is actually injected as the fuel injecting point in time when the fuel amount change time in which the fuel amount is changed due to the injection of the fuel is the injecting confirmation time or more, thereby making it possible to allow the internal combustion engine 20 to be operated in an appropriate time based on the fuel leaving time period in the fuel tank.

Meanwhile, the controller 200 may be configured to operate the internal combustion engine 20 for a pre-stored fuel consuming time or more when the period elapsing from the fuel injecting point in time reaches the fuel leaving time period. In other words, when the fuel injecting point in time is the fuel leaving time period or more, and the fuel remaining in the fuel tank is determined to be aged, the controller 200 may be configured to operate the internal combustion engine 20 while the hybrid vehicle is driven, and adjust an operation time of the internal combustion engine 20 to be the pre-stored fuel consuming time or more, thereby allowing the fuel in the fuel tank to be sufficiently consumed. The fuel consuming time may be, for example, a time of about 20 minutes or more, to sufficiently operate the internal combustion engine 20 to allow the fuel in the fuel tank to be sufficiently consumed.

As described above, the controller may be configured to operate the internal combustion engine 20 for the fuel consuming time or more while being forcibly operated, thereby making it possible to allow the fuel in the fuel tank to be sufficiently consumed. Additionally, the controller may be configured to operate the electric motor or the internal combustion engine based on a driving state of the hybrid vehicle when the period elapsing from the fuel injecting point in time does not reach the fuel leaving time period. In other words, when the time period elapsing from the engine driving point in time does not reach the fuel leaving time period, the controller 200 may be configured to operate only the electric motor 10 during low speed torque driving and operate only the internal combustion engine 20 or both of the electric motor 10 and the internal combustion engine 20 during high speed torque driving, thereby making it possible to drive the hybrid vehicle.

As described above, the time in which the internal combustion engine is operated and the time in which the fuel is injected into the fuel tank may be detected to determine the aging of the fuel when the internal combustion engine is not operated for a substantial period of time or the fuel amount in the fuel tank is not changed for a substantial period of time, thereby making it possible to allow the internal combustion engine 20 to be forcibly operated to consume the fuel in the fuel tank. As a result, a problem due to the aging of the fuel may be prevented in advance.

According to the fuel management system for a hybrid vehicle having the structure as described above, when the internal combustion engine is not operated by driving the hybrid vehicle by only the electric motor, causing the fuel to remain unused for a substantial period of time, the engine may be forcibly driven while the hybrid vehicle is driven, thereby allowing the unused fuel to be consumed. Particularly, the time when the internal combustion engine was last operated, the time in which the fuel was injected, and the change amount of the fuel may be detected as conditions for forcibly driving the engine to determine whether the fuel remains in the fuel tank, thereby preventing the aging of the fuel. Therefore, problems such as corrosion of the fuel tank, corrosion of an engine driving component, and a decrease of an engine output may be prevented.

Although the present invention has been illustrated and described with respect to specific exemplary embodiments, it will be obvious to those skilled in the art that the present invention may be variously modified and altered without departing from the spirit and scope of the present invention as defined by the following claims

What is claimed is:

1. A fuel management system for a hybrid vehicle driven by an electric motor and an internal combustion engine, comprising:
a check unit configured to detect a time in which the internal combustion engine was last operated and store the detected time as an engine driving point in time; and
a controller configured to receive the stored engine driving point in time and determine that fuel remaining in a fuel tank is aged when a time period elapsing from the engine driving point in time reaches a set fuel leaving time period, to forcibly operate the internal combustion engine while the hybrid vehicle is driven.

2. The fuel management system for a hybrid vehicle of claim 1, wherein the detected engine driving point in time is a date and a time in which the internal combustion engine was last operated.

3. The fuel management system for a hybrid vehicle of claim 1, wherein the check unit is configured to detect whether an operation maintaining time after an operation of the internal combustion engine reaches a pre-stored driving confirmation time, and store a point in time in which the internal combustion engine is currently operated as the engine driving point in time when the operation maintaining time is the driving confirmation time or more.

4. The fuel management system for a hybrid vehicle of claim 1, wherein the controller is configured to operate the internal combustion engine for a pre-stored fuel consuming time or more when the time period elapsing from the engine driving point in time reaches the fuel leaving time period.

5. The fuel management system for a hybrid vehicle of claim 1, wherein the controller is configured to operate the electric motor or the internal combustion engine based on a driving state of the hybrid vehicle when the time period elapsing from the engine driving point in time is less than the fuel leaving time period.

6. A fuel management system for a hybrid vehicle driven by an electric motor and an internal combustion engine, comprising:
a check unit configured to detect a time in which a fuel was last injected and store the detected time as a fuel injecting point in time; and
a controller configured to receive the stored fuel injecting point in time and determine that a fuel remaining in a fuel tank is aged when a time period elapsing from the fuel injecting point in time reaches a set fuel leaving time period, to forcible operate the internal combustion engine while the hybrid vehicle is driven.

7. The fuel management system for a hybrid vehicle of claim 6, wherein the detected fuel injecting point in time is a date and a time in which the fuel was last injected.

8. The fuel management system for a hybrid vehicle of claim 6, wherein the check unit is configured to store a point in time in which the fuel is currently injected as the fuel injecting point in time when a fuel amount change time in which a fuel amount is changed due to injection of the fuel into the fuel tank after the injection of the fuel is a pre-stored injecting confirmation time or more.

9. The fuel management system for a hybrid vehicle of claim 6, wherein the controller is configured to operate the internal combustion engine for a pre-stored fuel consuming time or more when the time period elapsing from the fuel injecting point in time reaches the fuel leaving time period.

10. The fuel management system for a hybrid vehicle of claim 6, wherein the controller is configured to operate the electric motor or the internal combustion engine based on a driving state of the hybrid vehicle when the time period elapsing from the fuel injecting point in time is less than the fuel leaving time period.

11. A fuel management control method for a hybrid vehicle driven by an electric motor and an internal combustion engine, comprising:
detecting, by a sensor, a time in which the internal combustion engine was last operated and store the detected time as an engine driving point in time; and
receiving, by a controller, the stored engine driving point in time and determining that fuel remaining in a fuel tank is aged when a time period elapsing from the engine driving point in time reaches a set fuel leaving time period, to forcibly operate the internal combustion engine while the hybrid vehicle is driven.

12. The fuel management control method for a hybrid vehicle of claim 11, wherein the detected engine driving point in time is a date and a time in which the internal combustion engine was last operated.

13. The fuel management control method for a hybrid vehicle of claim 11, further comprising:
detecting, by the sensor, whether an operation maintaining time after an operation of the internal combustion engine reaches a pre-stored driving confirmation time; and
storing, by the sensor, a point in time in which the internal combustion engine is currently operated as the engine driving point in time when the operation maintaining time is the driving confirmation time or more.

14. The fuel management control method for a hybrid vehicle of claim 11, further comprising:
operating, by the controller, the internal combustion engine for a pre-stored fuel consuming time or more when the time period elapsing from the engine driving point in time reaches the fuel leaving time period.

15. The fuel management control method for a hybrid vehicle of claim 11, further comprising:
operating, by the controller, the electric motor or the internal combustion engine based on a driving state of the hybrid vehicle when the time period elapsing from the engine driving point in time is less than the fuel leaving time period.
